(19) United States
(12) Patent Application Publication
(10) Pub. No.: US 2007/0229307 A1
(43) Pub. Date: Oct. 4, 2007

(54) Detection technology for vehicular and other security applications

(76) Inventors: Ivan Pawlenko, Holland, PA (US); Larry Samson, Langhorne, PA (US)

Correspondence Address: PATTI , HEWITT & AREZINA LLC, ONE NORTH LASALLE STREET, 44TH FLOOR, CHICAGO, IL, 60602, US

(21) Appl. No.: 11/395,988

(22) Filed: Mar. 31, 2006

(51) Int. Cl. G08G 1/01; G05B 19/00

(52) U.S. Cl. 340/933; 340/5.1

(57) ABSTRACT

An apparatus and method are provided for detecting whether a vehicle has been altered to conceal contraband. The invention involves receiving a detected signature of sensors embedded in a vehicle, in which the detected signature is a function of i) a distinctive characteristic of the sensors embedded in areas of the vehicle, ii) a number of the sensors embedded in areas of the vehicle, and iii) locations of the sensors in the vehicle. Afterwards, the detected signature is compared to a stored reference signature to determine whether there exists at least one difference between the stored reference signature and the detected signature. If a difference exits, then an alert is produced to notify inspectors that a detailed search is required in a specific area of the vehicle.

### TECHNICAL FIELD

This invention relates to the use of detection technology for inspecting vehicles.

### BACKGROUND

The flow of people and goods across borders of the United States helps to drive the economy of the United States, but this flow may also serve as a conduit for terrorists, undocumented migrants, and contraband, e.g., illegal drugs, weapons, explosives, agricultural products, etc. In many instances, contraband enters the United States via vehicles, e.g., a) an automobile, b) an airplane, c) a train, or d) a boat, and via storage containers carried on ships. Disadvantageously, detailed searches, such as those performed at border crossings, airports and harbors can only be performed on a small percentage of the vehicles and storage containers entering the country without disrupting the flow of traffic and commerce, stopping what many people believe is just a small percentage of the contraband entering the country.

Detection of contraband entering the country in a vehicle may be done with a) license plate readers connected to a law enforcement data base to determine if the vehicle has been stolen or involved in suspicious activities, b) portable x-ray machines to scan objects carried in the vehicle and large x-ray machines to scan truck trailers, c) inspectors to observe and question a suspicious driver and passengers, and to search the vehicle, d) fiber scope camera-type equipment to check for the presence of contraband in a gas tank, e) density checking tools to identify inconsistencies in tire density which would indicate possible contraband concealment, and f) trained drug sniffing dogs to search for scents emitted from the vehicle. For areas of the vehicle not easily visible by the inspector, e.g., the underside of the vehicle, use may be made of a mirror attached to an extended rigid handle, e.g., a long rod or a staff, to enable the inspector to view such areas. If an anomaly is detected, then the vehicle may be physically inspected.

Detection of contraband entering the country in storage containers may be done visually with a) x-rays or gamma rays to produce images of the contents of storage containers and b) submersible pole cameras, and, if an anomaly is detected, then the storage container may be physically inspected.

Disadvantageously, a mirror attached to a staff only provides a limited view of the total underside of the vehicle. Also disadvantageously, the use of x-rays, gamma rays, fiber scope camera-type equipment, submersible pole cameras, or mirrors attached to staffs provide inspectors no way to compare what is being seen to what is appropriate to be present for the particular vehicle or storage container being inspected. Further disadvantageously, trained drug sniffing dogs cannot detect other types of contraband, e.g., weapons and explosives.

### SUMMARY

It has been recognized, in accordance with the principles of the invention, that the problems of the prior art can be overcome by a detection technology for vehicles system. More specifically, the detection technology for vehicles system assists with inspections at border crossings by a) receiving a detected signature of sensors embedded in a vehicle, wherein the detected signature is a function of i) a distinctive characteristic of the sensors embedded in areas of the vehicle, ii) a number of the sensors embedded in areas of the vehicle, and iii) locations of the sensors in the vehicle; and b) comparing the detected signature to a stored reference signature to determine whether there exists at least one difference between the stored reference signature and the detected signature.

### DESCRIPTION OF THE DRAWINGS

FIG. 1 shows a view of an illustrative embodiment of the present invention of a detection technology for vehicles system; and

FIG. 2 shows an illustrative flow chart for a method of operating the detection technology for vehicles system.

### DETAILED DESCRIPTION

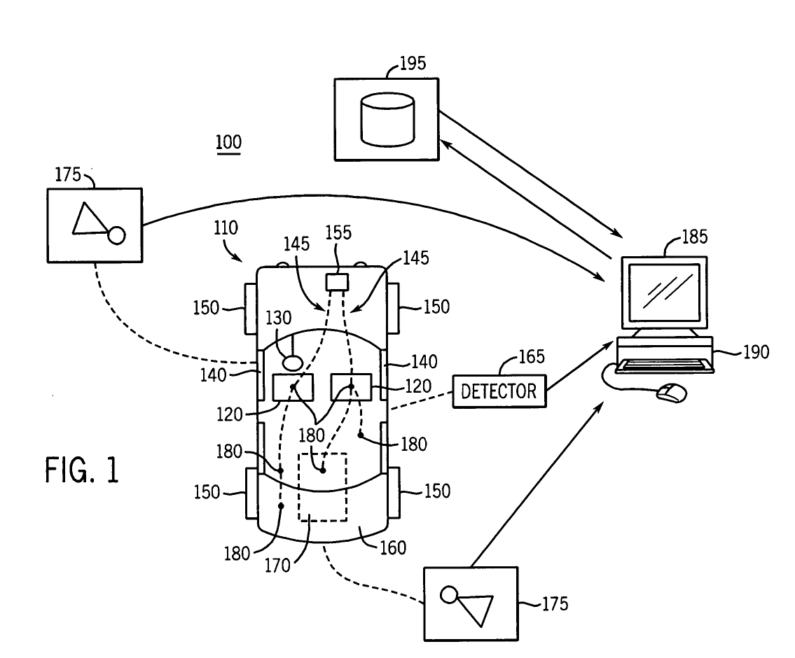

FIG. 1 is a diagram illustrating a detection technology for vehicles system 100 arranged in accordance with the principles of the invention. As shown in FIG. 1, is vehicle 110, a vehicle to be inspected at a checkpoint at which detection technology for vehicles system 100 is implemented. Vehicle 110 has seats 120, steering column 130, doors 140, wheels 150, trunk 160, and fuel compartment 170. Also, shown in FIG. 1 are wires 145, telemetering device 155, device detector 165, cameras 175, sensors 180, monitor 185, processor 190 and database 195.

Vehicle 110 is a commercially available self-propelled structure capable of transporting people and objects between a starting point and an end point. Vehicle 110 has seats 120 upon which people or objects rest in sitting, a steering column 130 for controlling the direction of transport of vehicle 110, doors 140 for entering and leaving vehicle 110, an engine, not shown, that provides power for vehicle 110 to transport people and objects between the starting point and the end point, wheels 150 that turn around an axle, not shown, for moving vehicle 110 between the starting point and the end point, trunk 160 for storing objects, and fuel compartment 170 for storing fuel needed to operate vehicle 110. In one embodiment of the invention, vehicle 110 may be an automobile. In another embodiment of the invention, vehicle 110 may be an airplane, a train, or a boat. In yet another embodiment, vehicle 110 may be a storage container carried on a truck or a train.

In one embodiment of the invention, at the time of vehicle manufacture, the interior of vehicle 110 may be embedded with one or more of sensors 180 in various locations which are most likely subject to modification from individuals attempting to alter the structure of vehicle 110 to conceal contraband inside vehicle 110. Sensors 180 may be mounted and positioned in a way such that each of sensors 180 is permanently attached to the area in which it is located. Illustratively, one or more of sensors 180 may be embedded in a) an inside of one or more of doors 140, b) fuel compartment 170, c) an inside of one or more of seats 120, d) trunk 160 or e) other locations, e.g., an engine compartment. In another embodiment of the invention, one or more of sensors 180 may already be built into parts of vehicle 110 that the manufacturer procures from a supplier.

Sensors 180 provide a detectable distinctive characteristic, e.g., a distinct identifier, a unique or distinctive pattern, a chemical residue, etc., which, when coupled with the locations of sensors 180 and the number of sensors 180 embedded in vehicle 110, provides a signature of sensors 180 in vehicle 110 when the embedded sensors 180 are detected.

In one embodiment of the invention, sensors 180 may be one or more programmable chip devices that provide a distinct identifier. The one or more programmable chip devices may be attached to areas of vehicle 110 by use of an adhesive having strength properties such that any attempt to reposition the one or more programmable chip devices will result in the destruction of the one or more programmable chip devices. In this embodiment, sensors 180 may be connected to a transponder, e.g., telemetering device 155, via wires 145. Telemetering device 155 may be positioned behind a front grill of vehicle 110 and mounted on any frame member adjacent to the front grill, or telemetering device 155 may be integrated with any component adjacent to the front grill, so that telemetering device 155 may transmit and receive radio frequency signals without interference from the metal body of vehicle 110.

At security checkpoints, telemetering device 155 may receive signals, e.g., queries, from detector 165 in an attempt to detect a signature of sensors 180, i.e., the one or more programmable chip devices. Upon receiving the queries from detector 165, telemetering device 155 queries the one or more programmable chip devices to identify themselves. The one or more programmable chip devices respond to the queries from telemetering device 155 with the distinct identifier that may include, at a minimum, the locations of each of sensors 180, and may include other information such as a make, model, year of manufacture, color, and Vehicle Identification Number (VIN) of vehicle 110. Upon gathering the distinct identifier of the one or more programmable chip devices, telemetering device 155 may transmit the distinct identifier and the number of programmable chip devices embedded in vehicle 110 to detector 165.

If the signal from telemetering device 155 is detected by detector 165, then the detected distinct identifier may be transmitted to a processor, e.g., processor 190, and compared to a stored reference distinct identifier. If the signal from telemetering device 155 is not detected or if the one or more programmable chip devices are not in the correct location, then it may be assumed that vehicle 110 has been altered. An inspector may be alerted to perform a detailed search of vehicle 110 when differences exist.

In another embodiment of the invention, sensors 180 may be one or more of piece parts composed of a predetermined material, e.g., metal, wood, etc., that is easily identifiable when viewed, and that is embedded in specific areas of vehicle 110. In this embodiment, the entire vehicle 110 or areas of vehicle 110 may be scanned via x-rays or other sensing technology at security check points or other locations to detect the signature of sensors 180 in vehicle 110 based on the one or more piece parts. The signature may be a particular image, a distinctive pattern, or other detectable characteristic that may vary depending on the location of the one or more piece parts in vehicle 110. Illustratively, the one or more piece parts may be composed of lead, shaped as alphabets and arranged to spell predetermined words, such as its location, and located in a rear passenger seat of vehicle 110. If the predetermined words are detected, then the scanned image may be transmitted to a processor and compared to a stored reference signature. If the predetermined words are not detected, or if the predetermined words are not in the correct location, e.g., the rear passenger seat of vehicle 110, or if the piece parts are composed of a material other than the material used in an original piece part, e.g., lead, then it may be assumed that vehicle 110 has been altered.

In yet another embodiment of the invention, sensors 180 may be a harmless chemical substance, e.g., perfluorocarbons, which is not perceivable by a human sense of smell that is deposited in predetermined areas of vehicle 110. In this embodiment, a hand-held chemical detector may be used to detect the presence of the chemical substance and to transmit the detected signature to a processor for comparison to a stored reference signature. If the chemical substance is not detected in the correct location of vehicle 110, then it may be assumed that vehicle 110 has been altered.

Detector 165 receives and identifies signatures of sensors 180 detected from vehicles at security checkpoints. After receiving a signature, detector 165 transmits the signature to processor 190. In one embodiment, detector 165 may be a transceiver that queries a telemetering device via radio frequency signals. In another embodiment, detector 165 may be an x-ray scanner. In yet another embodiment, detector 165 may be a chemical detector.

Cameras 175 may be digital cameras, scanners, a machine vision system, or the like. An image captured by cameras 175 may be analyzed using well-known character recognition techniques to determine the characters contained in the area. The image area may be analyzed by cameras 175, or in conjunction with, or wholly by a processor, e.g., processor 190. The resulting character string is transmitted to a processor and stored by the processor.

Processor 190 may be any type of processor. Processor 190 can perform signature matching techniques so as to determine whether a detected signature and a reference signature match. Processor 190 should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. The functions of processor 190 may be provided by a single dedicated processor, by a single shared processor, or by a plurality of individual processors, some of which may be shared.

In one embodiment of the invention, processor 190 may be a conventional computer that has software to perform signature matching available to it. Also, processor 190 may be able to display, e.g., on monitor 185, the differences identified by the signature matching, e.g., the expected location of a missing device. This difference will direct inspectors to the most likely area or areas of vehicle 110 that have been modified. Processor 190 is connected to database 195.

Database 195 stores reference signatures of sensors embedded in vehicles as they should appear if the vehicle is unaltered. The reference signatures are organized so that when information identifying a particular vehicle, or type of vehicle, is presented, the corresponding reference signatures may be retrieved. Thus, illustratively, database 195 may store reference signatures of sensors 180, and the stored reference signatures will be retrieved in response to presentation of an identifier of vehicle 110.

Various techniques exist to identify a vehicle. Illustratively, in the imaging applications system disclosed in U.S. patent application Ser. No. 11/172,003, filed Jun. 30, 2005, entitled DIGITAL IMAGING FOR VEHICULAR AND OTHER SECURITY APPLICATIONS, by Pawlenko et al., which is hereby incorporated by reference, vehicle identifying information may be obtained a) from character information written on the vehicle; b) from coded information printed on the vehicle, e.g., bar code or other pattern information; c) from a radio frequency identification (RFID) type tag in the vehicle; d) from a port on the vehicle, such as may be connected to the vehicle's computer; or e) from the shape and details of the exterior of the vehicle. Thus, the identifier for vehicle 110, may include i) a license plate number, ii) a vehicle identification number (VIN), iii) year, make and model information, iv) RFID tag data, and v) bar code data. Database 195 may be stored local to processor 190, or remote therefrom.

The reference signatures, i.e., the type of sensor, the number of sensors embedded, the locations of embedded sensors, etc., used to populate database 195 may be supplied by a vehicle manufacturer, which could supply information of the type and number of sensors used and the locations of the sensors in a particular type of vehicle immediately after manufacturing the vehicle. Also, a vehicle dealer could supply the signature information before delivery of the vehicle to its buyer, so that the signature information may be stored after post manufacture vehicle customization.

Those of ordinary skill in the art will readily be able to select sensors, detectors, cameras, telemetering devices, processors, and data bases appropriate for use in any particular implementation of a detection technology for vehicles system.

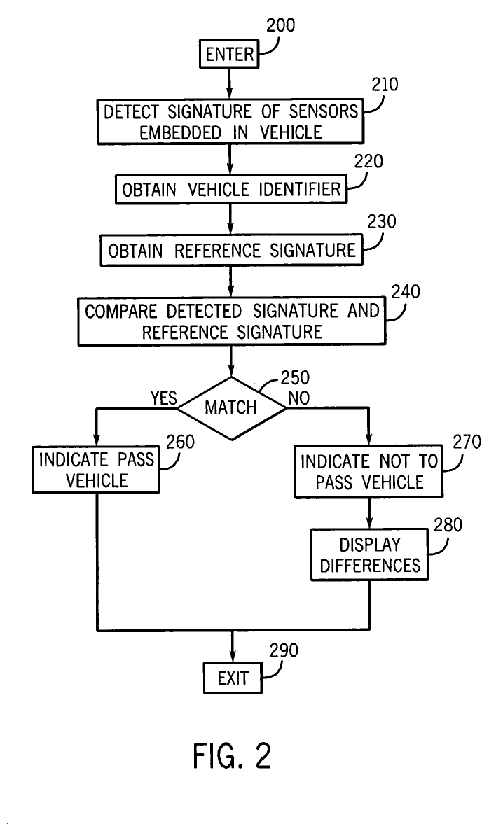

FIG. 2 shows a flow chart of the operation for a detection technology for vehicles system in accordance with the principles of the present invention. The process is entered in step 200 when a vehicle approaches a checkpoint equipped with detection technology for vehicles system 100, such as is shown in FIG. 1.

In step 210 (FIG. 2), detector 165 (FIG. 1) obtains a signature of sensors 180 embedded in vehicle 110 when vehicle 110 is positioned at the checkpoint. The signature of sensors 180 is a function of a) a distinctive characteristic of sensors 180 embedded in areas of vehicle 110, b) a number of sensors 180 embedded in areas of vehicle 110, and c) locations of sensors 180 in vehicle 110. Next, detector 165 transmits the signature to processor 190.

In step 220 (FIG. 2), cameras 175 (FIG. 1) obtain a vehicle identifier, e.g., i) a license plate number; ii) a VIN; iii) a RFID tag number; iv) a bar code; v) the year, make and model type of vehicle 110; or other information identifying vehicle 110 and transmits the identifier to processor 190. This step may be performed when vehicle 110 is positioned within range of camera 175, and possibly in conjunction with processor 190.

In step 230 (FIG. 2), processor 190 (FIG. 1) obtains a reference signature of sensors 180 embedded in vehicle 110 from data base 195. The reference signature is obtained as a function of the vehicle identifier obtained in step 220.

In step 240 (FIG. 2), the detected signature of sensors 180 in vehicle 110 (FIG. 1) is compared with the reference signature of sensors 180 to determine if there are any differences. Thereafter, conditional branch point 250 (FIG. 2) tests to determine if any differences were detected when doing the comparison in step 240.

In step 250 (FIG. 2), if the test result in step 250 is YES, indicating that the detected signature and the reference signature match, and therefore vehicle 110 (FIG. 1) is considered unaltered, and hence safe to pass through the checkpoint, control passes to step 260 (FIG. 2), in which a signal indicating that vehicle 110 (FIG. 1) is safe to pass through the checkpoint is generated. The process is then exited in step 290 (FIG. 2). If the test result in step 250 is NO, indicating that the detected signature and the reference signature do not match, vehicle 110 (FIG. 1) is identified as likely to have been altered, and hence not safe to pass, but instead to be a candidate for further inspection. Therefore, control passes to step 270 (FIG. 2), in which a signal indicating that vehicle 110 (FIG. 1) is not safe to pass through the checkpoint is generated. Control is then passed to step 280 (FIG. 2).

In optional step 280, differences between the detected signature and the reference signature may be pointed out. The reference signature and the detected signature may be displayed side by side on a monitor for the convenience of a human operator. An inspector may be alerted to perform a detailed search of vehicle 110 when differences exist.

The process is exited in step 290.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method of inspecting a vehicle, comprising the steps of:
receiving a detected signature of sensors embedded in the vehicle, wherein the detected signature is a function of a) a distinctive characteristic of the sensors embedded in areas of the vehicle, b) a number of the sensors embedded in areas of the vehicle, and c) locations of the sensors in the vehicle; and
comparing the detected signature to a stored reference signature to determine whether there exists at least one difference between the stored reference signature and the detected signature.

2. The method of claim 1 wherein the sensors are embedded in areas of the vehicle selected from the group consisting of: a) at least one inside door of the vehicle, b) a fuel compartment of the vehicle, c) at least one seat of the vehicle, d) an engine compartment of the vehicle, and e) a trunk of the vehicle.

3. The method of claim 2 wherein the sensors are at least one of the group consisting of: i) at least one programmable chip device, ii) piece parts composed of a predetermined material, and wherein the piece parts are arranged in a particular pattern, and iii) harmless chemical substances not perceivable by a human sense of smell.

4. The method of claim 1 wherein the step of comparing the detected signature to the stored reference signature further comprises the steps of:
obtaining an identifier of the vehicle; and
obtaining the stored reference signature from a database as a function of the identifier.

5. The method of claim 4 wherein the identifier is selected from the group consisting of: i) a license plate number, ii) a vehicle identification number (VIN), iii) year, make and model information, iv) radio frequency identification (RFID) tag data, and v) bar code data.

6. The method of claim 1 wherein the vehicle is selected from the group consisting of a) an automobile, b) an airplane, c) a train, and d) a boat.

7. The method of claim 1 further comprising the step of producing an alert that a detailed searched of the vehicle is required when it is determined that the at least one difference exists.

8. A method of operating a system for inspecting a vehicle, the method comprising the steps of:
receiving, with a detector, a signal from a transponder installed in the vehicle, wherein the signal carries locations of at least two programmable devices embedded in different areas in the vehicle;
comparing, with a processor, the locations of the at least two programmable devices received from the detector to stored reference locations of the at least two programmable devices; and
determining, with the processor, whether there exists at least one difference between the received locations and the stored reference locations.

9. The method of claim 8 further comprising the step of producing an alert that a detailed searched of the vehicle is required when the result of the determining step is that there exists the at least one difference.

10. The method of claim 8 further comprising the step of displaying the at least one difference to a human being.

11. An apparatus, comprising:
means for comparing a detected signature of sensors embedded in a vehicle to a stored reference signature to determine whether there exists at least one difference between the reference signature and the detected signature;
wherein the detected signature is a function of a) a distinctive characteristic of the sensors embedded in areas of the vehicle, b) a number of the sensors embedded in areas of the vehicle, and c) locations of the sensors in the vehicle.

12. The apparatus of claim 11 wherein the sensors are embedded in areas of the vehicle selected from the group consisting of: a) at least one inside door of the vehicle, b) a fuel compartment of the vehicle, c) at least one seat of the vehicle, d) an engine compartment of the vehicle, and e) a trunk of the vehicle.

13. The apparatus of claim 12 wherein the sensors are at least one of the group consisting of: i) at least one programmable chip device, ii) piece parts composed of a predetermined material, and wherein the piece parts are arranged in a particular pattern, and iii) harmless chemical substances not perceivable by a human sense of smell.

14. The apparatus of claim 11 wherein the means for comparing is a processor performing a signature matching process.

15. The apparatus of claim 11 wherein the reference signature is stored in a data base.

16. The apparatus of claim 15 wherein the reference signature is specified by an identifier of the vehicle.

17. The apparatus of claim 16 wherein the identifier is at least one of the group consisting of: i) a license plate number, ii) a vehicle identification number (VIN), iii) year, make and model information, iv) a radio tag identifier number, and v) a bar code.

18. The apparatus of claim 11 wherein the vehicle is selected from the group consisting of a) an automobile, b) an airplane, c) a train, and d) a boat.

19. The apparatus of claim 11 further comprising means for producing an alert that a detailed searched of the vehicle is required when it is determined that the at least one difference exists.

20. The apparatus of claim 11 further comprising means for displaying the at least one difference to a human being.
